(19) United States
(12) Patent Application Publication
(10) Pub. No.: US 2006/0204166 A1
(43) Pub. Date: Sep. 14, 2006

(54) Method and apparatus for monitoring and calibrating an emissive pixel

(76) Inventors: W. Edward Naugler JR., Cedar Park, TX (US); Damoder Reddy, Los Gatos, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 11/136,230

(22) Filed: May 23, 2005

Related U.S. Application Data
(60) Provisional application No. 60/663,838, filed on Mar. 14, 2005.

(51) Int. Cl. G02B 6/12

(52) U.S. Cl. 385/14; 385/89

(57) ABSTRACT

The present invention provides techniques to calibrate the emissive pixels used in printers and displays. The emissive pixels are arranged in a linear array or in a two dimensional array. For the transparent substrate on which the emissive pixels are formed, the light emitted by a pixel is measured by attaching one or more optical sensors, either directly or via optical fibers, to the transparent surfaces of the transparent substrate. That measurement is compared to a reference value and corrections are accordingly made to the emissive pixels. In case of a printer, the emissive pixels can be tested for their luminescent strengths in the period following the printing of a page while the next page to be printed is being positioned.

### RELATED APPLICATION

This application claims the benefit of U.S. Provisional Application No. 60/663,838, filed Mar. 14th, 2005, which is incorporated herein by reference.

### FIELD OF THE INVENTION

The present invention relates to emissive pixels used in printheads and displays, and specifically to monitoring and calibrating the emissive pixels.

### BACKGROUND OF THE INVENTION

Emissive pixels are used in printers and displays. In the displays, the emissive pixels are arranged in two-dimensional arrays. There can be several million emissive pixels in a television or a computer display depending on the size of the display. The resolution of a display is defined in terms of the number of pixels per square inch of the display. The higher the resolution, the better the picture shown on the display. An emissive pixel is typically turned on and off by using a voltage source. In addition to turning the pixel on and off, the voltage source is typically also used to control the gray scale of the pixel.

A gray scale is a scale of achromatic colors having several equal gradations ranging from white to black. At a given gray scale, the emissive pixel is designed to illuminate at a certain predetermined brightness level depending on the design criteria that was used to design the particular display. As the display ages, there is often a decline in an emissive pixel's luminescent strength such that it becomes progressive dim. Non-uniformities in the fabrication of the emissive pixels during manufacturing also adversely affect the luminescent qualities of the emissive pixels. This problem is amplified in the displays that use the new organic light emitting diodes (OLED) to illuminate the emissive pixels, and that is inhibiting the commercialization of the OLED technology.

The aging problem associated with the display pixels is also applicable to the printhead pixels. Presently, the printer technology only uses linear arrays of emissive pixels. Applicants are not aware of any prior art in the area of printer technology that discloses a two-dimensional array of emissive pixels. The published Japanese Patent Application No. 2000-349576 (P2000-349576) to Hiromasa Sugano (“Sugano Publication”) seems to disclose a printhead having a two dimensional array of emissive pixels in FIGS. 1, 4 and 7 at the first glance, but that disclosure is ridden with enablement problems and discloses a system that is unworkable.

FIGS. 1 and 7 of the Sugano Publication show an optical head 51 having a two dimensional array of picture elements 100 arranged in rows and columns. Each picture element pixel 100 of a column of picture elements 100 is shown connected to the detector circuit 130 via the same input line 131 to the detector circuit 130. FIG. 4 of the Sugano Publication shows that the line 131 is connected to the anode of the photodiode PD and the capacitor Cs of each picture element 100. The current discharged by the capacitor Cs into the line 131 is purportedly detected by the detector circuit 130 to determine the light emitted by the photo emitter diode LD. Sugano Publication at ¶27.

That arrangement is unworkable because the capacitors Cs for all the picture elements 100 of a column discharge in the same line 131 and the detector circuit 130 cannot separate the discharges from the various capacitors Cs. Also, the discharging of the capacitor Cs is problematic because the line 131 is not connected to the ground. Furthermore, the Sugano Publication does not disclose if the paper must be momentarily stopped so that the two dimensional array of pixels can be flashed and the image data emitted by the emissive pixels for forming the image on the paper. If the Sugano Publication intends to flash the two-dimensional array of emissive pixels while the paper is moving, the details of how that would be accomplished are not disclosed.

There is a need in the art to stabilize the light emissions of the emissive pixels throughout the life span of the printers and the displays.

### SUMMARY OF THE INVENTION

In one aspect of the present invention a device, such as a display or a printhead of a printer, is disclosed having a substrate having a transparent portion including one or more transparent surfaces. One or more arrays of emissive pixels are embedded in the substrate for emitting light. An optical sensor is externally coupled to a transparent surface of the substrate. The transparent portion of the substrate provides a path for a light emitted by an emissive pixel of the one or more arrays of emissive pixels to exit through the transparent surface. The optical sensor is optically coupled to the emissive pixel by means of the path. The optical sensor is configured to detect the light emitted by the emissive pixel that exists the transparent surface. The optical sensor can be embedded in a wall of a receptacle module designed for holding the substrate.

In another aspect of the present invention, a method for a printhead of a printer having one or more arrays of emissive pixels is disclosed. Initially, a page is printed. Following, a plurality of emissive pixels of the one or more arrays is stopped from emitting light. Following, an emissive pixel of the plurality of emissive pixels is caused to emit light. Following, the light emitted by the emissive pixel s detected. Following, a measurable parameter for the detected light is calculated. Following, the measurable parameter for the detected light is compared with a threshold value. Finally, a result of the comparison is stored in a memory location.

In yet another aspect of the present invention, a substrate for a display or a printhead of a printer is disclosed including a linear array of emissive pixels and an optical sensor strip that runs the length of the linear array of emissive pixels and overlaps with a plurality of the emissive pixels of the linear array. The optical sensor strip is optically coupled to the emissive pixels of the linear array of emissive pixels. The shortest distance between any emissive pixel of the plurality of pixels of the linear array and the optical sensor strip is the same for all the emissive pixels of the plurality of pixels of the linear array.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates an exemplary flowchart of a method for calibrating emissive pixels;

FIG. 2a and FIG. 2b illustrate exemplary transparent substrates;

FIG. 3 illustrates an exemplary substrate including an optical sensor strip optically coupled to emissive pixels;

FIG. 4a, FIG. 4b, FIG. 4c and FIG. 4d illustrate exemplary embodiments of optical sensors attached to transparent substrates;

FIG. 5a and FIG. 5b illustrate other exemplary embodiments of optical sensors attached to transparent substrates;

FIG. 6a and FIG. 6b illustrate exemplary embodiments of optical sensor receptacles having embedded optical sensors and cavities for holding transparent substrates;

FIG. 7a and FIG. 7b illustrate exemplary embodiments of optical sensors attached to transparent substrates by means of optical fibers;

FIG. 8 illustrates an exemplary embodiment of an optical sensor receptacle having embedded optical fibers connected to an optical sensor and a cavity for holding a transparent substrate; and

FIG. 9 illustrates an exemplary flowchart of a method for calibrating emissive pixels.

### DETAILED DESCRIPTION OF THE INVENTION

According to one aspect of the present invention, the present invention uses luminance feedback from emissive pixels to stabilize and make uniform a linear array or a two dimensional array of emissive pixels deposed on a transparent substrate of a printhead or a display. A printhead is a device used to write an image to light sensitive materials including photographic media and photosensitive drums designed to pick up toner inks for transfer to non-optically sensitive materials such as paper stock, transparencies and others.

Feedback systems are sorted into three broad classes: closed loop, open loop, and interrupted loop. The closed loop is a system in which a change is detected in the output of a system and directly fed back to the input, which causes another output, which is again fed back to the input. An oscillator is an example of a closed loop system. If there is enough damping in an oscillating system the system will eventually settle to a constant output value. The exact value and the time it takes to settle are dependent on the loop parameters. The open loop system does not feed back output values directly to the system input. Rather an output value is measured, evaluated and the result of the evaluation is used to make a decision on changing the input at a point in the future. The interrupted loop starts with a varying input and as the output varies, it is measured and compared to a reference. When the output matches the reference, the input is interrupted and input value held. Thus, the output is fixed at a desired value determined by the reference. This is a fast and highly accurate method to achieve a desired output.

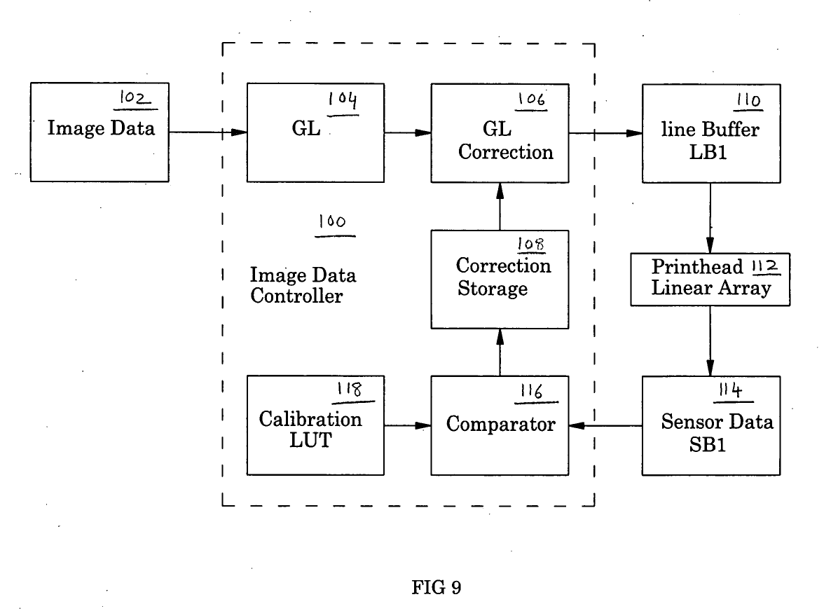

In one aspect of the present invention, luminescence feedback is implemented using the open loop technique. The open loop technique for a printhead is now described with reference to FIG. 9, which shows a flowchart of the functionality of the image data controller 100. Image data 102 is fed to the gray level block (GL) 104, which converts the image data to gray levels. The number of gray levels depends on the number of bits used to define the gray level. For example, a 1 bit gray level has two levels-on or off. An 8-bit gray level has 0 to 255 levels of gray. The image data is a serial data stream of analog pixel values (voltages). An analog pixel voltage enters block GL 104 and a digital number representing the gray level corresponding to the analog voltage exits.

The digital gray level value enters block GL Correction 106 and may or may not be changed depending on the information inputted from block Correction Storage 108. The gray level value (changed or unchanged) exits the GL Correction block 106 and enters the Line Buffer (LB1) block 110, which collects pixel values until one line of pixels is collected, at which point the total line of pixel values is down loaded to the Printhead Linear Array block 112.

The values of the down loaded pixels determine the luminance levels of the light emitters in the printhead. The value of the luminance over the time the printhead is on is collected and read to the Sensor Data (SB1) buffer block 114. The sensor data is sent to the Comparator block 116, which compares the sensor data to calibration (reference) data sent to the Comparator block 116 from the Calibration LUT (look-up table) block 118. The two pieces of data are subtracted and the resulting value is sent to the Correction Storage block 108. The values stored in the Correction Storage Block 108 are gray levels or portions of gray levels that will be added or subtracted from the initial gray level determined from the incoming image data and converted to a gray level in the GL block 104.

The advantage of the open loop feedback system of FIG. 9 is that the luminance data is collected during a time interval, which will tend to cancel out random noise generated in the optical signal plus the optical signal will be amplified by a factor determined by dividing the measurement time into the integration time. For example, if the time interval (integration time) is 40 microseconds and the measurement time is 8 microseconds the amplification is 5 times or 7 dB.

The open loop method illustrated in FIG. 9 is an exemplary one. Other methods are available such as the ones disclosed in the provisional application No. 60/660,725, filed by Applicants on Mar. 11th, 2005, which is incorporated herein by reference. The open loop techniques of the present invention can be implemented in passive, active, or COG (chip on glass) circuitry or in any combination thereof as is explained in the provisional application No. 60/660,725.

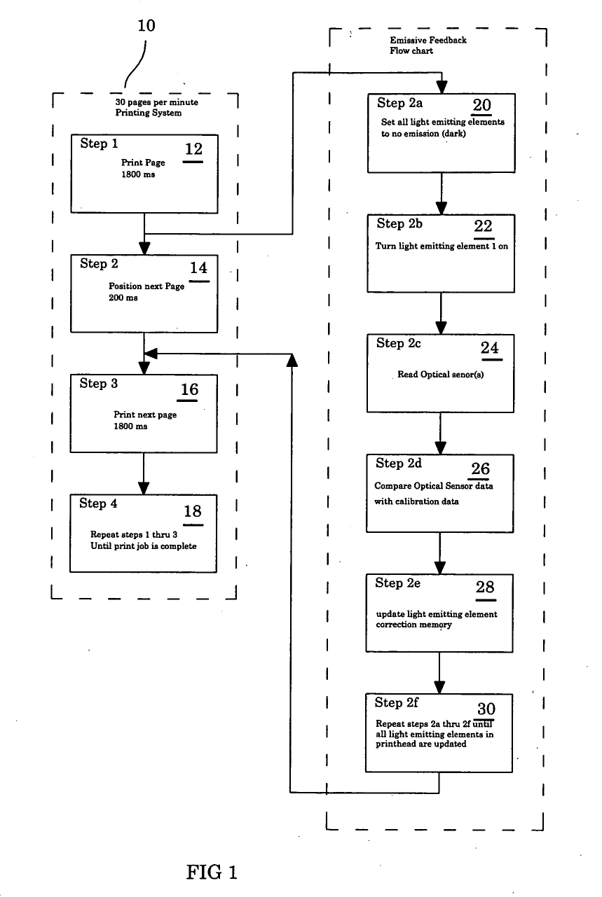

FIG. 1 shows a flow chart of a method for implementing an emissive feedback technique in a printhead that does not have a one-to-one correspondence between the light emitting elements and optical sensors. According to block 12, in step 1, a first page is printed using the printhead. The printhead may include a linear array or a two dimensional array of emissive pixels. The linear arrays are well know in the industry and are used regularly with laser printers. In block 14, after the first page is printed, step 2 includes the positioning of the next page to be printed. The amount of time to do this depends on the pages per minute to be printed and the length of the page.

For example, if 30 10-inch pages are to be printed per minute the rate of page travel is 300 in/min or 5 in/sec. If the distance from the last printed line on the first page to the first printed line on the next page is 1 inch, then the time to position the next page is 200 ms or 200,000 microseconds. According to blocks 16 and 18, step 3 includes printing the next page and step 4 includes repeating steps 1, 2 and 3 until the printing job is completed. Step 2 is the critical step in the emissive feedback operation. Step 2 is subdivided into steps 2a-2f as illustrated in blocks 20-30.

According to block 20, in step 2a, all light emitting elements are set to no emission (dark). According to block 22, in step 2b, a first light-emitting element in a printhead array is turned on to the highest design luminance (this is an example and any luminance level can be used). According to block 24, in step 2c, the luminance of the first light-emitting element is detected and converted into a measurable parameter such as a voltage reading. A read circuitry can be used to perform step 2c, for example, the read circuitry disclosed in the provisional application No. 60/660,725.

According to block 26, in step 2d, the measurable parameter value, for example, the voltage reading, measured in step 2c is compared with e reference value. The reference value can be stored in a table is a memory and correspond to the desired luminance of the light emitting element for a given set of circumstances, for example, for certain environmental conditions. According to block 28, in step 2e, a result of the comparison made in step 2d is stored in a memory location. According to block 30, in step 2f, steps 2a-2e are repeated for more light emitting elements of the one or more arrays of light emitting elements of the printhead. The number of the light emitting elements that can be tested for calibration according to step 2f depends on the time required to position the next page in block 14.

In order to produce the circuitry or the present invention, for example, the substrate, various techniques well known in the semiconductor industry are used including: material deposition processes including but not limited to evaporation, sputtering and plasma enhanced chemical vapor deposition; etching processes including but not limited to wet chemical etching, reactive ion etching and sputter etching; and photolithographic processes.

A printhead or a display substrate may be transparent in the case of a down-emitter OLED (organic light emitting diode) or made of an opaque material in the case of an up-emitter OLED. Terms “down-emitter” and “up-emitter” are familiar terms used in the OLED industry signifying whether or not the light emitted by the OLED materials passes down through the substrate or up and away from the substrate. Both systems are in common use in the industry.

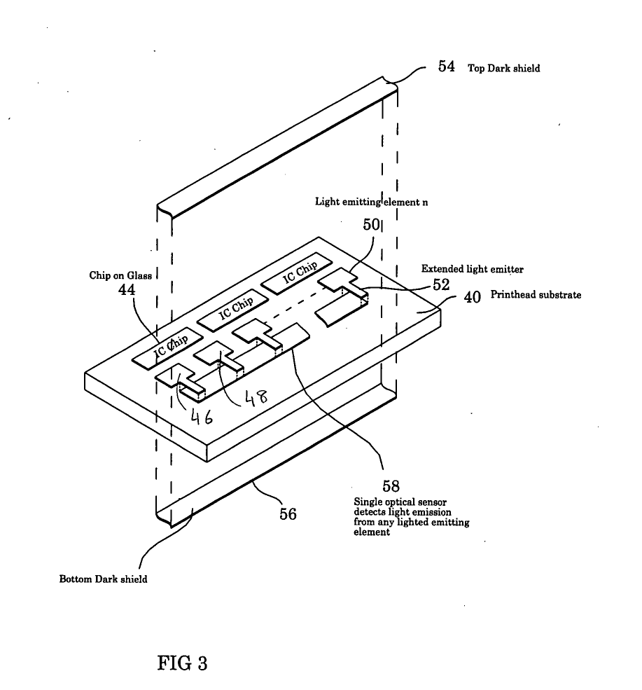

FIG. 3 shows the light emitting elements running linearly down the center of the printhead substrate 40, or a display substrate 40, with the pixel driver circuitry 44 in the upper third of the printhead and a single optical sensor 58 in the bottom third of the printhead body. The drive circuitry 44 shown in the diagram is a COG. (chip on glass) IC. Alternately, the drive circuitry 44 may be fabricated in thin film. Alternately, the drive circuitry 44 may be located off the substrate 40 on a companion printed circuit board or as an IC chip mounted on flex circuitry attached to the printhead substrate 40. Alternately, any combination of COG, thin film or off glass circuitry may be used.

It is understood that the light emitting elements 46, 48, 50 may be formed from a number of light emitting materials including but not limited to organic light emitting diode materials such as Kodak's small molecule material, the polymer OLED materials, and phosphorescent OLED materials introduced by the Universal Display Corporation. Other light emitting materials including electroluminescent materials and inorganic materials such as the indium phosphides used in the well known red LEDs may also be used.

The optical sensor 58 is comprised of an optically sensitive material, such as amorphous silicon, poly-silicon or any other material that changes electrical properties under changing levels of illumination. In the embodiment shown in FIG. 3, a single sensor strip 58 runs the length of the linear light emitting element array 46, 48, 50. A projection of light emitting material 52 from each light-emitting element 46, 48, 50 overlaps a portion of the optical sensor strip 58. During the read step (step 2c in FIG. 1), the light emitting elements 46, 48, 50 are turned on one at a time beginning with the first light emitting element 46 and ending with the nth light-emitting element 50. In the printing example given above, the time to position the next page is 200,000 microseconds.

If the linear array in the printhead has 5,000 light emitting elements, the time to read each element is 40 microseconds. When the first light-emitting element 46 is turned on, the photon emission from the light emitting element projection 52 overlapping a portion of the single optical sensor 58 couples light into the sensor 58, which sends an optical signal proportional to the level of light emission to the read circuitry (not shown). There are many types of read circuitry available to designers skilled in electrical engineering; and several such circuits were described in the provisional application No. 60/660,725.

As described above with reference to, FIG. 9 the optical data read from the optical sensor 58 for the first light-emitting element 46 is compared to the calibrated data and the difference (if there is a difference) is stored in the Correction Storage Block 108. One by one, data from each light-emitting element 46, 48, 50 in the one or more arrays on the printhead is read, compared to the calibrated data and the differences stored in the Correction Storage Block 108 until all 5,000 light-emitting elements 50 are read. This operation takes 200 ms to complete, and thus, occurs during the time it takes to position the next page for printing.

It is understood that the reading of all light emitting elements in 200 ms is an example and only a portion of the light emitting elements may be read during the positioning of the next page with the balance of the light emitting elements being read during following positioning of pages. For example, half the light emitting elements could be read per page change, or 1/10^{th} of the light emitting elements could be read per page change. Any number of light emitting elements could be read per page change, which would extend the reading and updating of light emitting elements over many pages. It is conceivable that only one light-emitting element 50 may be read and that it would take 5000 pages to complete the light emitting element update. At 30 pages per minute this would only be an on time of the printhead of 166 minutes, or less than three hours. While this is a long a period between updates for the present materials, more stable materials may be developed in the future that may not need an update for at least 166 minutes.

In the above example, one thin film optical sensor 58 was used to read all the light emitting elements in the printhead linear array. Alternatively, groups of light emitting elements could be read by one thin film optical sensor per group. For example, ten thin film optical sensors could be used to read five groups of fifty light-emitting elements, allowing data to be read in parallel for ten light-emitting diodes at a time. The groups of light emitting elements could range from 2 to 2500, for example, and anywhere in between.

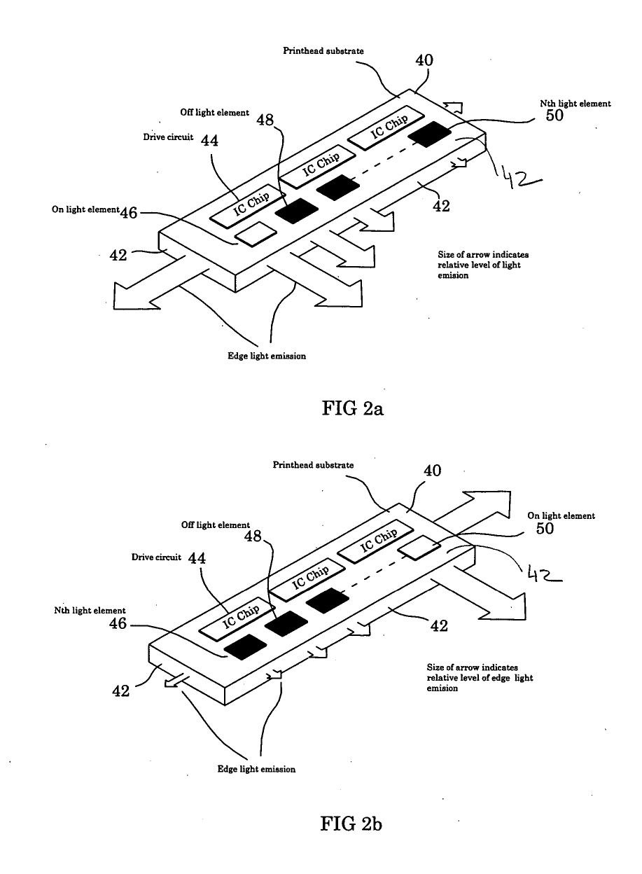

FIGS. 2a and 2b show that light inserted into the transparent printhead substrate 40 by an emissive pixel 46 can exit the glass substrate 40 through the edges of the glass 42. FIG. 2a shows that the light emitted from the edges 42 located nearest the illuminated light emitting element 46 is the most intense (arrow size indicating light emission intensity) and that the least intensity is on the edges 42 located most remotely from the illuminated light emitting element 46. FIG. 2b shows the nth light-emitting element 50 is illuminated and inserting light into the glass substrate 40, and therefore, the intensity of the light emission from the edges 42 is the reverse of that shown in FIG. 2a. One of ordinary skill in the art will appreciate that the substrate 40 shown in FIGS. 2a and 2b can be a printhead substrate or a display substrate.

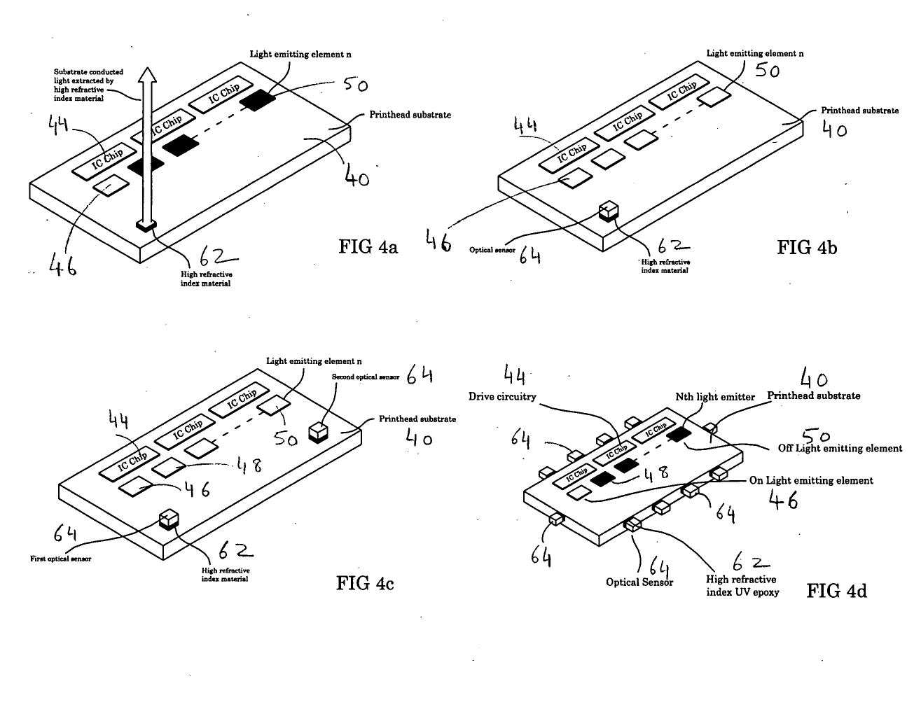

FIG. 4a shows that if an optical coupling material 62 is in contact with the top surface 42 of the printhead or the display substrate 40, light inserted into the substrate by a light-emitting element 46 can be extracted through the optical coupling material 62. The physics of manipulating the path that light follows using varying refractive index materials is well known in the industry and is made use of particularly in the fiber optics area. FIG. 4b shows an optical sensor 64 attached to the optical coupling material 62. The optical coupling material 62 may be a UV cured epoxy, which adheres to both the glass substrate 40 and the optical detector 64.

Alternately, any adhesive material that serves to both extract light from the substrate 40 and can adhere the substrate 40 to the optical sensor 64 may be used. The optical sensor 64 may be selected from many types of optically active materials including but not limited to silicon diodes, germanium diodes, cesium compounds, selenium compounds, and materials used to make solar cells naming a few. Alternately, thin film optically active materials can be deposed on the surface of the transparent substrate 40.

FIG. 4c shows that multiple optical sensors can be coupled into the transparent substrate 40 of the printhead. Multiple sensors 64 can be used to add to the total reading of one light-emitting element 46, 48, 50 at a time. Signal to noise ratio can determine the speed at which the optical sensor 64 can be read. Therefore, multiple optical sensors 64 can be advantageously used to increase the signal to noise ratio, and thus, the maximum speed of recording the optical sensor data from one light-emitting element 46, 48, 50. The optical sensors 64 are electrically wired to the substrate 40 (wires not shown). Cables (not shown) are subsequently attached to the printhead substrate 40 using technology well known in the industry. The cables conduct the optical readings to circuits for processing the information.

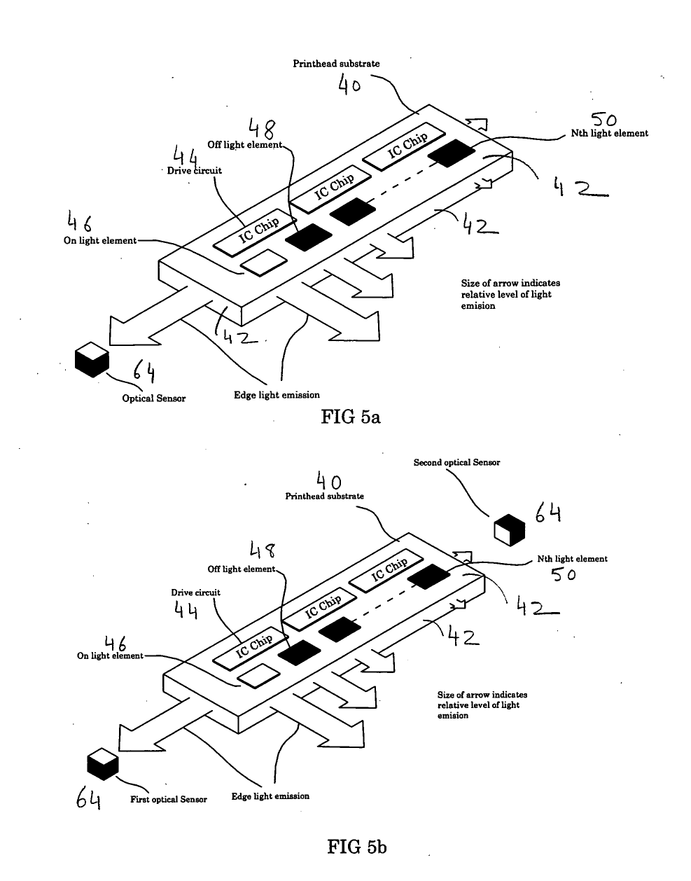

FIG. 5a shows an optical sensor 64 attached to one edge 42 of the transparent printhead substrate 40. The material used to attach the optical sensor 64 also extracts light from the edge 42. The illuminated light emitter element 46 will generate a light component that exits the transparent substrate 40 through its six sides 42 and a judicious selection of the epoxy bonding material may increase the intensity of the light exiting to the optical sensor 64. One optical sensor 64 can be used to read the light-emitting element 46, 48, 50. FIG. 5b shows another optical sensor 64 attached to the opposite side of the printhead transparent substrate 40 to increase and balance the optical signals from each light emitting element 46, 48, 50. In FIG. 4d, ten optical sensors 64 have been attached to the six sides 42 of the print head's transparent substrate 40, thereby increasing the signal to noise ratio by a factor of 10. The optical sensors 64 are electrically wired to a circuit board (not shown). One of ordinary skill in the art will appreciate that the substrate 40 shown in FIGS. 4a, 4b, 4c, 4d, 5a and 5b can be a printhead substrate or a display substrate.

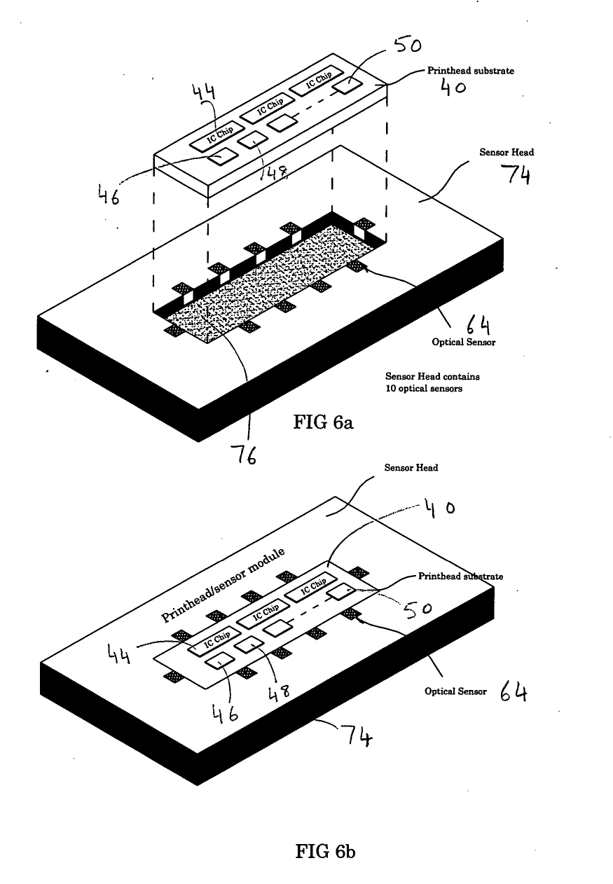

FIG. 6a shows a printhead substrate 40 containing the printhead drive circuitry 44 and the linear array of light emitting elements 46, 48, 50 being inserted into a module 74 containing embedded optical sensors 64. FIG. 6b shows the printhead substrate 40 fully inserted into the optical sensor module 64. The system is designed so that the printhead substrate 40 closely fits in the optical sensor-lined pocket 76. Optical coupling epoxy may be used to maximize the light extracted from the printhead substrate 40, which would also help hold the printhead substrate 40 in place.

As described above, a full range of optical sensors 64 is known in the art. The optical sensors 64 can be electrically connected into circuitry carried by the optical sensor module 74 in much the same manner as printed circuit boards are constructed. That is, the optical sensor module 74 may itself be a printed circuit board with the optical sensors 64 embedded therein. An advantage of this embodiment is that the printhead need not have any optical sensors 64 attached to it or deposed on its surface. Therefore, any printhead having a transparent substrate 64 may be made uniform and maintained to light emission specification using this embodiment. One of ordinary skill in the art will appreciate that the substrate 40 shown in FIGS. 6a and 6b can be a printhead substrate or a display substrate.

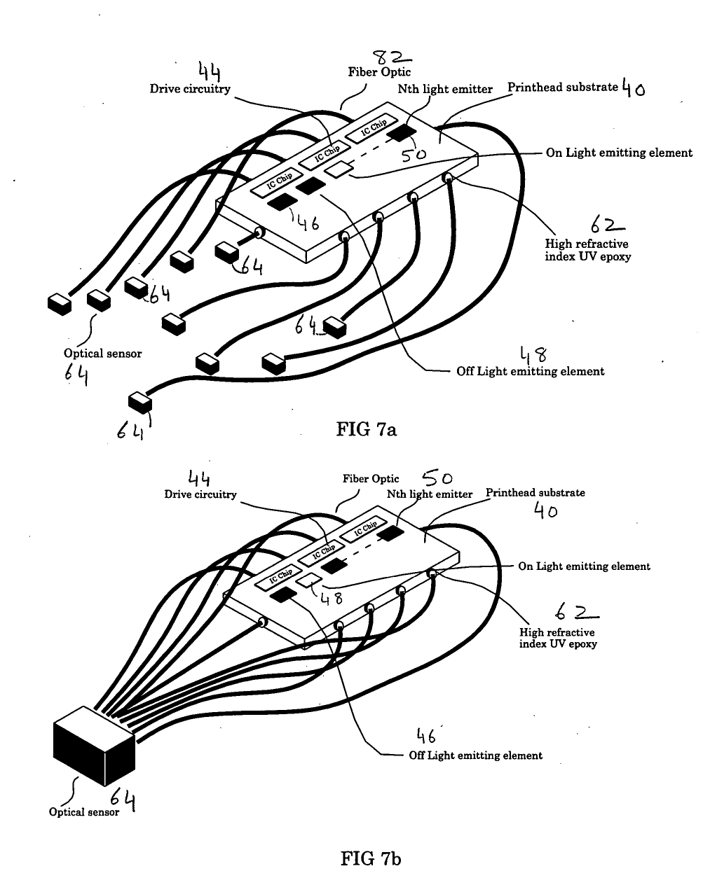

FIG. 7a shows optical fibers 82 replacing the edge attached optical sensors 64. Each optical fiber 82 conducts light from the printhead substrate 40 to an optical sensor 64. Alternatively, FIG. 7b shows all optical fibers 82 conducting light from the edges of the printhead substrate 40 to one optical sensor 64. There is no electro-optical difference between the apparatuses of the FIGS. 7a and 7b because adding electrical signals from 10 optical sensors, or alternately adding the light intensities from ten optical fibers provides approximately the same signal to noise ratio.

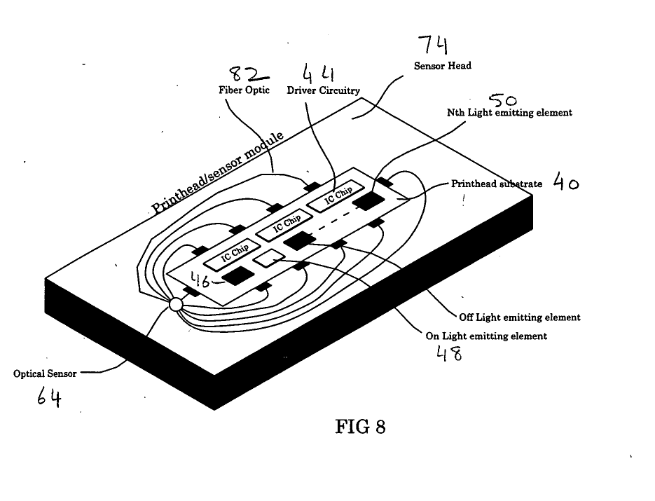

FIG. 8 shows the use of optical fibers 82 embedded in the optical sensor module 74 having one optical sensor 64. Alternately, multiple optical sensors 64 can be used in this embodiment and one or multiple optical fibers 82 can be connected to each optical sensor 64. Also, an optical fiber 82 could also be attached through high refractive index material 62 to the top or bottom surface 42 of the transparent printhead substrate 40. One of ordinary skill in the art will appreciate that the substrate 40 shown in FIGS. 7a, 7b and 8 can be a printhead substrate or a display substrate.

What is claimed is:

1. A device comprising:
a substrate having a transparent portion including one or more transparent surfaces;
one or more arrays of emissive pixels embedded in the substrate for emitting light;
an optical sensor externally coupled to a transparent surface of the substrate; wherein;
the transparent portion of the substrate provides a path for a light emitted by an emissive pixel of the one or more arrays of emissive pixels to exit through the transparent surface; and
the optical sensor is optically coupled to the emissive pixel by means of the path.

2. The device of claim 1, wherein the device includes a printhead for a printer.

3. The device of claim 1, wherein the device includes a display.

4. The device of claim 1, wherein the optical sensor is configured to detect the light emitted by the emissive pixel that exists the transparent surface.

5. The device of claim 1, further comprising:
the optical sensor is coated with an optical coupling material for enhancing the optical coupling between the optical sensor and the emissive pixel selected from the group consisting of an optical grease, an optical epoxy, and an ultra violet light cured epoxy.

6. The device of claim 1, further comprising:
the optical sensor is attached to the transparent surface by means of an adhesive optical coupling material to enhance the optical coupling between the optical sensor and the emissive pixel and for adhering the optical sensor to the substrate.

7. The device of claim 1, further comprising:
a plurality of optical sensors are attached externally to the one or more transparent surfaces of the substrate to optically couple the plurality of optical sensors with one or more emissive pixels of the one or more arrays of emissive pixels.

8. The device of claim 7, wherein the plurality of optical sensors are smaller in number than the number of emissive pixels of the one or more arrays of emissive pixels.

9. The device of claim 1, wherein the optical sensor is fabricated from a material selected from the group consisting of an amorphous silicon material, a poly-silicon material, a silicon diode, a germanium diode, a cesium compound, a selenium compound, a material which electrical parameter value is variable depending on the intensity level of the light to which it is exposed to, and a material used to make a solar cell.

10. The device of claim 1, wherein the emissive pixel includes a light emitting element selected from the group consisting of an organic light emitting diode, a light emitting diode, an electroluminescent cell, a plasma cell a field emission pixel, and a vacuum fluorescent pixel.

11. The device of claim 1, further comprising:
the optical sensor is configured to optically couple to a plurality of emissive pixels of the one or more arrays of emissive pixels.

12. The device of claim 11, wherein the intensity level of the light emitted by the emissive pixel exiting the transparent portion of the substrate is higher at a first location on the one or more transparent surfaces that is closer in proximity to the emissive pixel than a second location on the one or more transparent surfaces.

13. The device of claim 1, wherein the optical sensor communicates with the transparent surface by means of an optical fiber to optically couple with one or more emissive pixels of the one or more arrays of emissive pixels.

14. The device of claim 1, wherein the optical sensor communicates with the transparent surface by means of a plurality of optical fibers to optically couple with one or more emissive pixels of the one or more arrays of emissive pixels.

15. The device of claim 1, further comprising:
a plurality of optical sensors communicate with the one or more plurality of transparent surfaces of the substrate by means of a plurality of optical fibers to optically couple with one or more emissive pixels of the one or more arrays of emissive pixels.

16. The device of claim 1, wherein the optical sensor includes an optical sensor strip that runs the length of an array of emissive pixels of the one or more arrays of emissive pixels and overlaps the emissive pixels of the array.

17. The device of claim 1, wherein the emissive pixel includes a light emitting element fabricated from an organic light emitting diode material selected from the group consisting of a small molecule fluorescent material, a small molecule phosphorescent material, a polymeric fluorescent material, a polymeric phosphorescent material, and a combination thereof.

18. The device of claim 1, wherein the optical sensor is fabricated from an optically sensitive material selected from the group consisting of an amorphous silicon material, a poly-silicon material, and a material having an electrical parameter which value is variable depending on the intensity of light to which it is exposed to.

19. The device of claim 1, further comprising:
the optical sensor embedded in a receptacle module; wherein
the receptacle module is designed for holding the substrate; and
the optical sensor is embedded in a wall of the receptacle module.

20. The device of claim 19, further comprising:
the wall of the receptacle module is coated with an adhesive optical coupling material for enhancing the optical coupling between the optical sensor and the emissive pixel and for adhering the substrate to the wall.

21. The device of claim 19, wherein the receptacle module includes a printed circuit board having an embedded optical sensor.

22. The device of claim 19, further comprising:
a plurality of optical sensors embedded in the wall.

23. The device of claim 1, further comprising:
the optical sensor attached to the substrate by means of an optical fiber embedded in a receptacle module; wherein
the receptacle module is designed for holding the substrate; and
the optical fiber is embedded in a wall of the receptacle module.

24. The optical sensor module of claim 23, further comprising:
a plurality of optical fibers are embedded in the wall to optically couple one or more emissive pixels of the one or more arrays of emissive pixels with one or more optical sensors.

25. The device of claim 1, further comprising:
the optical sensor is coated with a high refractive index material to extract the light emitted by the emissive pixel.

26. A method for a printhead of a printer having one or more arrays of emissive pixels, the method comprising the sequential steps of:
a) printing a first page;
b) stopping a plurality of emissive pixels of the one or more arrays from emitting light;
c) causing an emissive pixel of the plurality of emissive pixels to emit light;
d) detecting the light emitted by the emissive pixel;
e) calculating a measurable parameter for the detected light;
f) comparing the measurable parameter for the detected light with a threshold value; and
g) storing a result of the comparison in a memory location.

27. The method of claim 25, further comprising:
h) positioning a second page for printing during the execution of the steps b, c, d, e, f and g.

28. The method of claim 26, further comprising:
repeating the sequential steps c, d, e, f and g for another emissive pixel of the plurality of emissive pixels before the completion of step h.

29. The method of claim 27, further comprising:
adjusting an input parameter of the emissive pixel depending on the comparison.

30. The method of claim 29, wherein the input parameter of the emissive pixel includes a voltage signal provided as an input to a light emitting element of the emissive pixel.

31. The method of claim 29, wherein adjusting includes increasing the voltage signal provided as an input to the light emitting element if the measurable parameter is below the threshold value and decreasing the voltage signal provided as an input to the light emitting element if the measurable parameter is above the threshold value.

32. The method of claim 26, wherein the measurable parameter includes a voltage value.

33. The method of claim 26, wherein detecting the light emitted by the emissive pixel includes detecting the light emitted by a light emitting element of the emissive pixel selected from the group consisting of an organic light emitting diode, a light emitting diode, an electroluminescent cell, a plasma cell a field emission pixel, and a vacuum fluorescent pixel.

34. A substrate comprising:
a linear array of emissive pixels; and
an optical sensor strip that runs the length of the linear array of emissive pixels and overlaps with a plurality of the emissive pixels of the linear array; wherein the optical sensor strip is optically coupled to the emissive pixels of the linear array of emissive pixels; and
the shortest distance between any emissive pixel of the plurality of pixels of the linear array and the optical sensor strip is the same for all the emissive pixels of the plurality of pixels of the linear array.

35. The substrate of claim 34, wherein every emissive pixel of the linear array includes an extended portion that overlaps with the optical sensor strip.

36. The substrate of claim 34, wherein an emissive pixel includes a light emitting element selected from the group consisting of an organic light emitting diode, a light emitting diode an electroluminescent cell, a plasma cell a field emission pixel, and a vacuum fluorescent pixel.

37. The substrate of claim 34, wherein the substrate includes substrate for a printhead for a printer.

38. The substrate of claim 34, wherein the substrate includes a substrate for a display.
